(19) United States
(12) Patent Application Publication
(10) Pub. No.: US 2008/0083719 A1
(43) Pub. Date: Apr. 10, 2008

(54) Fender well deicer (defroster)

(76) Inventor: John J. Bartucco, Meeker, CO (US)

Correspondence Address: Galasso & Associates, LP, P.O. Box 26503, Austin, TX, 78755-0503, US

(21) Appl. No.: 11/517,935

(22) Filed: Sep. 8, 2006

(51) Int. Cl. B60L 1/02

(52) U.S. Cl. 219/203

(57) ABSTRACT

Fender Well Deicer (Defroster) consists of a curved housing covering a heated layer that can be attached to a wheel well using an attaching mechanism such as a series of eyelets on the housing and a plurality of screws. A wire running from the heated layer to the interior of the car connects to a control for providing power to the device. When in use, the device prevents and/or removes ice and/or snow build-up within the wheel well by through the application of heat. The device operates from a vehicle's electrical system.

### CROSS REFERENCE TO RELATED APPLICATIONS

This Non-Provisional patent application does not claim priority to any U.S. provisional patent application nor any foreign patent application.

### FIELD OF THE DISCLOSURE

The disclosures made herein relate generally to the automobile accessories industry. The invention discussed herein is in the general classification of specialized defrosting devices.

### BACKGROUND

Millions of people worldwide consider the automobile and other motor vehicles to be significantly important in maintaining their lifestyle. Billions of dollars are spent on automobiles and automobile accessories every year. Because motor vehicles are constantly being operated, there is a high risk of accidents. This is particularly true during winter months when road conditions may be unfavorable and ice can build up on the roads and on the wheels of a motor vehicle.

Legislative and law enforcement bodies have taken particular interest in enacting and enforcing safety regulations for motor vehicle operators and manufacturers to insure the public's safety. For example, many states require the operator of a vehicle to use a seat belt when a vehicle is in motion. Manufacturers often must make vehicles that have certain specific components as part of their design. Manufacturers are now required to pass certain safety crash test and to install airbags within their motor vehicles.

Windshield wipers are another critically important feature necessary for safe operation of a vehicle. The defroster is an important safety feature that often works in conjunction with the windshield wiper to reduce the hazards of ice on the windshield. However, ice build up does not just occur on the windshield. Wheel wells of motor vehicles accumulate snow or ice that can affect the wheels and tires and prevent them from turning their proper distance or stopping abruptly, if necessary. Unfortunately, no effective solution to this problem has ever been proposed.

Hence, there is a need in the art for a convenient, inexpensive and effective device for removing ice/frost from the wheel wells of a motor vehicle.

### SUMMARY OF THE DISCLOSURE

Fender Well Deicer (Defroster) consists of a curved housing covering a heated layer that can be attached to a wheel well using an attaching mechanism such as screws. A wire running from the heated layer to the interior of the car connects to a control for providing power to the device. When in use, the device prevents and/or removes ice and/or snow build-up within the wheel well by the application of heat. The device operates using the vehicle's electrical system.

The principal object of this invention is to provide a device that can prevent ice or frost from accumulating in the wheel wells of a motor vehicle.

Another object of this invention is to provide a device that can remove ice or frost once it has accumulated in the wheel wells of a motor vehicle.

Another object of this invention is to provide a device that can be easily used and is effective in removing ice or frost from a wheel well and preventing ice and frost from forming in a wheel well.

Another object of this invention is to provide an affordable device for removing ice and frost from the wheel well and preventing ice and frost from forming in the wheel well of an automobile or other vehicle.

Yet another object of this invention is to provide an easy to install device for removing ice and frost from the wheel well and preventing ice and frost from forming in the wheel well of an automobile or other vehicle.

### BRIEF DESCRIPTION OF THE DRAWINGS

FIG. 1 depicts a perspective view of the preferred embodiment of the present invention.

FIG. 2 depicts a cut away view of the housing and heated layer of the preferred embodiment of the invention.

### DETAILED DESCRIPTION OF THE DRAWINGS

The preferred embodiment of Fender Well Deicer (Defroster) is comprised of at least some of the following: a curved housing to fit inside a wheel well that covers a heated layer. The curved housing can be attached to a wheel well using an attaching mechanism such as screws or bolts. An insulated wire running from the heated layer to the dashboard of the car connects to a control for providing power to the device.

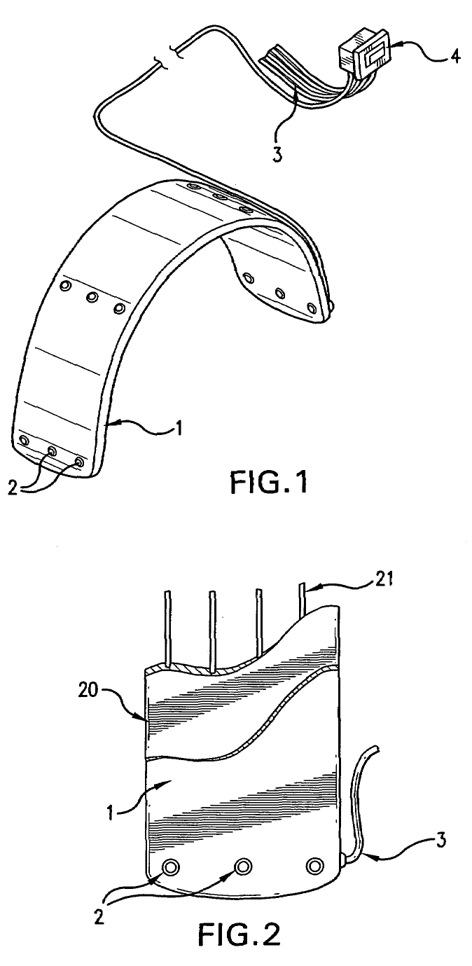

In the preferred embodiment of the invention, shown in FIG. 1, a curved housing 1 is shaped to fit within a wheel well. Because vehicles have various sized wheel wells, the housing 1 will necessarily come in a variety of sizes to accommodate different makes and models of vehicles. Ideally, the housing 1 will be made of plastic, rubber or other suitable material to protect the heated layer (not pictured) within the housing 1 from road debris. The housing 1 would be approximately one-quarter of an inch thick though any thickness that still allows the device to generate heat into the wheel well may be appropriate. A series of eyelets 2 for screw mounting to the wheel well are spaced along the housing 1. The eyelets 2 are ideally made of brass though any metal or other suitable material may be utilized. An insulated wire 3 operatively connects to the heated layer inside the housing 1. The other end of the insulated wire 3 connects to a dash mounted control 4 inside the vehicle. Ideally, there is an insulated wire connecting to the dash mounted control 4 for each wheel well of the vehicle.

FIG. 2 depicts the housing 1 and heated layer 20 of the preferred embodiment of the invention. The heated layer 20 is made of a conductive metal and has a series of heating elements 21 running through it. The eyelets 2 and insulated wire 3 of the invention are also depicted in this view.

In an alternative embodiment of the invention, a series of coils could be inside the heated layer and operatively connected to the insulated wire attached to the dash mounted control. Obviously, the control could also be attached to a variety of locations, but on or near the dashboard of a vehicle would be of maximum convenience for the user. The heated layer could also be a series of coils or heating elements inside the housing without the need for the conductive metal of the preferred embodiment.

To use Fender Well Deicer (Defroster) an operator turns the device on using the control on the dashboard causing electricity to run through the insulated wires to the heated layer. The heat generated prevents and/or removes ice and/or snow build-up within the wheel wells through the application of heat. When the user is finished with the device, he uses the control on the dashboard to terminate the power supply. The manual power control permits a user to only use the device during weather conditions conducive to snow or ice build-up. This also saves the vehicle's power because the device will not be in operation all of the time.

The components of Fender Well Deicer (Defroster) may vary widely but will likely use metal, plastic, and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Fender Well Deicer (Defroster) can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals or other suitable materials and can be of any color. It should further be obvious that although the present invention is ordinarily used for automobiles, it could be used with any motorized vehicle, including trucks, tractors and other farm equipment. It should also be obvious that while the preferred embodiment of the invention works by utilizing a vehicle's electrical power system, a separate source of power could also be used and still be within the spirit of the invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A wheel well defroster comprising:
(a) a housing;
(b) a heated layer within the housing;
(c) a wire operatively connected to the heated layer and to a power control; and
(d) an attaching mechanism to secure the housing to a wheel well.

2. The wheel well defroster of claim 1 wherein the housing is made of plastic.

3. The wheel well defroster of claim 1 wherein the housing is made of rubber.

4. The wheel well defroster of claim 1 wherein the housing is curved.

5. The wheel well defroster of claim 1 wherein the attaching mechanism is a plurality of eyelets on the housing and a plurality of screws.

6. The wheel well defroster of claim 1 wherein the attaching mechanism is a plurality of eyelets on the housing and a plurality of bolts.

7. The wheel well defroster of claim 5 wherein the plurality of eyelets are made of brass.

8. The wheel well defroster of claim 1 wherein the wire has an insulative cover.

9. The wheel well defroster of claim 8 wherein the insulative cover is plastic.

10. The wheel well defroster of claim 8 wherein the insulative cover is rubber.

11. The wheel well defroster of claim 1 wherein the power control is mounted to a dashboard inside a vehicle.

12. The wheel well defroster of claim 1 wherein the heated layer is made of a conductive metal and has a plurality of heating elements running through it.

13. The wheel well defroster of claim 1 wherein the heated layer is made of conductive metal and has a plurality of coils running through it.

14. A wheel well defroster comprising:
(a) a housing that is plastic and curved;
(b) a heated layer made of conductive metal and containing a plurality of heating elements located within the housing;
(c) a wire covered with a plastic insulative material operatively connected to the heated layer and to a power control that can be mounted to the dashboard of a vehicle; and
(d) a plurality of brass eyelets located on the housing.
